(19) United States
(12) Patent Application Publication
(10) Pub. No.: US 2020/0352163 A1
(43) Pub. Date: Nov. 12, 2020

(54) ANTIMICROBIAL MIXTURE CONTAINING 4-(3-ETHOXY-4-HYDROXYPHENYL)BUTAN-2-ONE AND AN AROMATIC ALCOHOL, AND COSMETIC COMPOSITION CONTAINING SAME

(71) Applicant: L'OREAL, Paris (FR)

(72) Inventors: Florence MENARD-SZCZEBARA, Chevilly Larue (FR); Sylvie CUPFERMAN, Chevilly Larue (FR); Julien GALVAN, Chevilly Larue (FR)

(21) Appl. No.: 16/626,100

(22) PCT Filed: Jun. 27, 2018
(86) PCT No.: PCT/EP2018/067310

§ 371 Date: Dec. 23, 2019

(30) Foreign Application Priority Data
Jun. 30, 2017 (FR) 1756156
Jun. 30, 2017 (FR) 1756166
Aug. 18, 2017 (FR) 1757741
Aug. 18, 2017 (FR) 1757743

(51) Int. Cl. A01N 31/16; A01N 31/14; A01N 25/02

(52) U.S. Cl. CPC A01N 31/16; A01N 25/02; A01N 31/14

(57) ABSTRACT

The invention relates to an antimicrobial mixture containing 4-(3-ethoxy-4-hydroxyphenyl)butan-2-one and an aromatic alcohol chosen from a phenoxyalcohol of formula (I) C₆H₆-0-R—OH, R denoting a divalent hydrocarbon-based radical having 2 or 3 carbon atoms; phenylethyl alcohol; benzyl alcohol; and a cresol compound of formula (I) in which R₁ denotes H or an isopropyl radical; and also to a cosmetic composition containing such a mixture. Use in caring for, making up and cleansing keratin materials.

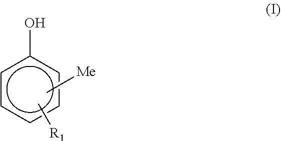

The subject of the present invention is an antibacterial mixture containing 4-(3-ethoxy-4-hydroxyphenyl)butan-2-one and an aromatic alcohol, and also a cosmetic composition containing such a mixture.

4-(3-Ethoxy-4-hydroxyphenyl)butan-2-one (ketone compound) is a useful substance as a preserving agent for cosmetic compositions, for protecting the compositions against microbial contamination, as described in patent application WO 2011/039445.

However, it is desirable to be able to incorporate said ketone compound in reduced concentration in compositions, especially cosmetic or dermatological compositions, while at the same time maintaining good antimicrobial conservation performance. Combinations of the ketone compound with other compounds that have antimicrobial efficacy are thus sought for this purpose.

The inventors have discovered, unexpectedly, that the combination of 4-(3-ethoxy-4-hydroxyphenyl)butan-2-one with an aromatic alcohol chosen from a phenoxyalcohol such as 2-phenoxyalcohol, phenylethyl alcohol and benzyl alcohol makes it possible to obtain an antimicrobial mixture which has synergistic antimicrobial activity.

The results of the examples described below show the synergistic antimicrobial activity obtained with the minimum inhibitory concentration (MIC) measurements taken with several mixtures. The antimicrobial activity is considered as being synergistic when the antimicrobial mixture makes it possible to obtain a percentage of strain growth of less than or equal to 20%, or even less than or equal to 25%.

The combination of 4-(3-ethoxy-4-hydroxyphenyl)butan-2-one with a phenoxyalcohol such as 2-phenoxyethanol makes it possible to obtain an antimicrobial mixture which has synergistic antimicrobial activity, in particular on moulds, in particular on Aspergillus niger, on gram-positive bacteria, in particular on Enterococcus faecalis and Staphylococcus aureus, on gram-negative bacteria, in particular on Pseudomonas aeruginosa, and on yeasts, in particular on Candida albicans.

Application FR-A-2962333 describes a cosmetic composition for the treatment of oily skin comprising a 2-alkoxy-4-alkyl ketone phenol and an essential oil. The composition may comprise an additional active agent for oily skin care, such as antimicrobial agents, among which mention is made of phenoxyethanol. This document does not specifically describe an antimicrobial mixture constituted of the combination of 4-(3-ethoxy-4-hydroxyphenyl)butan-2-one with phenoxyethanol, and also does not suggest that such a mixture has a synergistic antimicrobial activity on moulds, in particular on Aspergillus niger, on gram-positive bacteria, in particular on Enterococcus faecalis and Staphylococcus aureus, on gram-negative bacteria, in particular on Pseudomonas aeruginosa, and on yeasts, in particular on Candida albicans.

The combination of 4-(3-ethoxy-4-hydroxyphenyl)butan-2-one with the phenylethyl alcohol makes it possible to obtain an antimicrobial mixture with synergistic antimicrobial activity, in particular on yeasts, in particular on Candida albicans.

The combination of 4-(3-ethoxy-4-hydroxyphenyl)butan-2-one with benzyl alcohol makes it possible to obtain an antimicrobial mixture which has synergistic antimicrobial activity, in particular on moulds, in particular on Aspergillus niger, and on gram-positive bacteria, in particular on Enterococcus faecalis.

The combination of 4-(3-ethoxy-4-hydroxyphenyl)butan-2-one with a cresol compound, in particular 4-isopropyl-3-methylphenol, makes it possible to obtain an antimicrobial mixture which has synergistic antimicrobial activity, in particular on gram-positive in particular on Enterococcus faecalis, and on yeasts, in particular on Candida albicans.

A subject of the invention is an antimicrobial mixture comprising, or constituted of, 4-(3-ethoxy-4-hydroxyphenyl)butan-2-one and an aromatic alcohol chosen from:
i) a phenoxyalcohol of formula C₆H₅—O—R—OH, R denoting a divalent hydrocarbon-based radical having 2 or 3 carbon atoms;
ii) phenylethyl alcohol;
ii) benzyl alcohol;
iv) a cresol compound of formula (I):

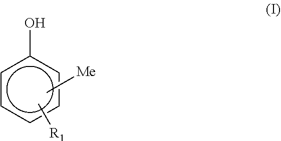

in which R₁ denotes H or an isopropyl radical.

A subject of the invention is also a composition, especially a cosmetic or dermatological composition, comprising, in a physiologically acceptable medium, said mixture described previously.

A further subject of the invention is a process for the non-therapeutic cosmetic treatment of keratin materials, comprising the application to the keratin materials of a composition as described previously. The process may be a cosmetic process for caring for or making up or cleansing keratin materials.

A subject of the invention is also a process for conserving a composition comprising a physiologically acceptable medium, in particular a cosmetic or dermatological composition, characterized in that it consists in incorporating into said composition an antimicrobial mixture as described previously.

A subject of the invention is also the use of the antimicrobial mixture described previously for conserving a composition comprising a physiologically acceptable medium.

4-(3-Ethoxy-4-hydroxyphenyl) butan-2-one is a compound of formula:

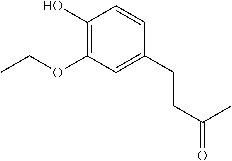

According to a first embodiment, a subject of the invention is an antimicrobial mixture comprising, or constituted of, 4-(3-ethoxy-4-hydroxyphenyl)butan-2-one and a phenoxyalcohol of formula C₆H₅—O—R—OH, R denoting a divalent hydrocarbon-based radical having 2 or 3 carbon atoms.

The phenoxyalcohol described previously can be chosen from 2-phenoxyethanol or 1-phenoxy-2-propanol. 2-Phenoxyethanol is preferably used.

2-Phenoxyethanol corresponds to the compound of formula C₆H₅—O—CH₂—CH₂—OH (CAS No.: 122-99-6).

Advantageously, 4-(3-ethoxy-4-hydroxyphenyl)butan-2-one and the phenoxyalcohol previously described are present in said mixture in a content such that the 4-(3-ethoxy-4-hydroxyphenyl)butan-2-one/phenoxyalcohol weight ratio ranges from 0.15 to 3.5, preferably ranges from 0.15 to 3.2, and more preferentially ranges from 0.2 to 3.2.

The antimicrobial mixture may have a 4-(3-ethoxy-4-hydroxyphenyl)butan-2-one/phenoxyalcohol weight ratio ranging from 0.6 to 1.6, preferably ranging from 0.7 to 1.4, preferentially ranging from 0.8 to 1.2 and more preferentially ranging from 0.9 to 1.1. Such a mixture has good antimicrobial activity on moulds, especially on Aspergillus niger.

The antimicrobial mixture may have a 4-(3-ethoxy-4-hydroxyphenyl)butan-2-one/phenoxyalcohol weight ratio ranging from 0.4 to 0.8, preferably ranging from 0.45 to 0.7 and more preferentially ranging from 0.45 to 0.6. Such a mixture has good antimicrobial activity on the gram-positive bacterium Enterococcus faecalis.

The antimicrobial mixture may have a 4-(3-ethoxy-4-hydroxyphenyl)butan-2-one/phenoxyalcohol weight ratio ranging from 0.3 to 3.2, preferably ranging from 0.3 to 2.4, preferably ranging from 0.3 to 1.4 and more preferentially ranging from 0.3 to 1.2. Such a mixture has good antimicrobial activity on the gram-positive bacterium Staphylococcus aureus.

The antimicrobial mixture may have a 4-(3-ethoxy-4-hydroxyphenyl)butan-2-one/phenoxyalcohol weight ratio ranging from 0.2 to 3.2, preferably ranging from 0.4 to 3.2, preferably ranging from 0.8 to 3.2, preferably ranging from 1.6 to 3.2, preferably ranging from 0.2 to 2.4, preferably ranging from 0.4 to 2.4, preferentially ranging from 0.8 to 2.4 and more preferentially ranging from 1.6 to 2.4. Such a mixture has good antimicrobial activity on gram-negative bacteria, especially on Pseudomonas aeruginosa.

The antimicrobial mixture may have a 4-(3-ethoxy-4-hydroxyphenyl)butan-2-one/phenoxyalcohol weight ratio ranging from 0.15 to 1.3, preferably ranging from 0.15 to 0.7 and preferentially ranging from 0.25 to 0.5. Such a mixture has good antimicrobial activity on yeasts, in particular on Candida albicans.

According to a second embodiment, a subject of the invention is an antimicrobial mixture comprising, or constituted of, 4-(3-ethoxy-4-hydroxyphenyl)butan-2-one and phenylethyl alcohol.

The phenylethyl alcohol corresponds to the compound 2-phenylethyl alcool (CAS No.: 60-12-8) of formula:

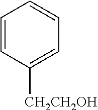

Advantageously, 4-(3-ethoxy-4-hydroxyphenyl)butan-2-one and the phenylethyl alcohol are present in said mixture in a content such that the 4-(3-ethoxy-4-hydroxyphenyl)butan-2-one/phenylethyl alcohol weight ratio ranges from 0.05 to 1, preferably ranging from 0.09 to 0.9 and preferentially ranging from 0.3 to 0.85.

According to a third embodiment, a subject of the invention is an antimicrobial mixture comprising, or constituted of, 4-(3-ethoxy-4-hydroxyphenyl)butan-2-one and benzyl alcohol.

Benzyl alcohol (CAS No.: 100-51-6) corresponds to the compound of formula:

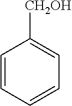

Advantageously, 4-(3-ethoxy-4-hydroxyphenyl)butan-2-one and the benzyl alcohol are present in said mixture in a content such that the 4-(3-ethoxy-4-hydroxyphenyl)butan-2-one/benzyl alcohol weight ratio ranges from 0.1 to 1.5, and preferably ranges from 0.1 to 1.2.

The antimicrobial mixture according to the invention has synergistic antimicrobial activity, in particular on moulds, especially on Aspergillus niger, and on gram-positive bacteria, in particular on Enterococcus faecalis.

The antimicrobial mixture may have a 4-(3-ethoxy-4-hydroxyphenyl)butan-2-one/benzyl alcohol weight ratio ranging from 0.15 to 0.8, preferably ranging from 0.2 to 0.6. Such a mixture has good antimicrobial activity on moulds, especially on Aspergillus niger.

The antimicrobial mixture may have a 4-(3-ethoxy-4-hydroxyphenyl)butan-2-one/benzyl alcohol weight ratio ranging from 0.1 to 1.5, preferably ranging from 0.1 to 1.2. Such a mixture has good antimicrobial activity on the gram-positive bacterium Enterococcus faecalis.

According to a fourth embodiment, a subject of the invention is an antimicrobial mixture comprising, or constituted of, 4-(3-ethoxy-4-hydroxyphenyl)butan-2-one a cresol compound defined below.

The cresol compound used according to the invention is a compound of formula (I):

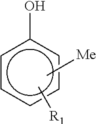

in which R₁ denotes H or an isopropyl radical.

The compound of formula (I) may be chosen from 3-methylphenol (CAS number 108-39-4), 2-methylphenol (CAS number 95-48-7), 4-methylphenol (CAS number 106-44-5) and 4-isopropyl-3-methylphenol (CAS number 3228-02-2). Preferably, the compound of formula (I) is 4-isopropyl-3-methylphenol.

Advantageously, 4-(3-ethoxy-4-hydroxyphenyl)butan-2-one and the cresol compound of formula (I) are present in said mixture in a content such that the 4-(3-ethoxy-4-hydroxyphenyl)butan-2-one/compound (I) weight ratio ranges from 0.5 to 15, preferably ranges from 1 to 15 and more preferentially ranges from 1 to 12.

Preferentially, the antimicrobial mixture according to the invention contains 4-isopropyl-3-methylphenol.

The antimicrobial mixture may have a 4-(3-ethoxy-4-hydroxyphenyl)butan-2-one/cresol compound (I) (in particular 4-isopropyl-3-methylphenol) ranging from 2 to 15, preferably ranging from 2.2 to 15 and more preferentially ranging from 2.2 to 12. Such a mixture has good antimicrobial activity on the gram-positive bacterium Enterococcus faecalis.

The antimicrobial mixture may have a 4-(3-ethoxy-4-hydroxyphenyl)butan-2-one/cresol compound (I) (in particular 4-isopropyl-3-methylphenol) ranging from 0.5 to 15, preferably ranging from 1 to 15, preferably ranging from 1 to 12, and more preferentially ranging from 2 to 8. Such a mixture has good antimicrobial activity on yeasts, in particular on Candida albicans.

A subject of the invention is also a composition comprising, in a physiologically acceptable medium, the antimicrobial mixture described previously.

The term “physiologically acceptable medium” is intended to mean a medium that is compatible with human keratin materials such as the skin, the scalp, the hair and the nails. Said medium may comprise one or more additional ingredients, different from the ketone compound and from the 2-phenoxyethanol and/or from the phenylethyl alcohol and/or from the benzyl alcohol and/or from the cresol compound of formula (I).

The compound 4-(3-ethoxy-4-hydroxyphenyl)butan-2-one may be present in the composition according to the invention in a content ranging from 0.01% to 5% by weight relative to the total weight of the composition, preferably ranging from 0.01% to 3% by weight, preferentially ranging from 0.01% to 2.5% by weight and more preferentially ranging from 0.01% to 2% by weight.

The composition may comprise at least one additional ingredient chosen from water, oils, polyols containing from 2 to 10 carbon atoms, gelling agents, surfactants, film-forming polymers, colorants, fragrances, fillers, UV-screening agents, plant extracts, cosmetic and dermatological active agents, and salts.

The composition according to the invention may comprise an aqueous phase.

The composition may comprise water, which may be present at a content ranging from 5% to 90% by weight relative to the total weight of the composition, and preferably ranging from 35% to 75% by weight.

The composition may also comprise a polyol that is water-miscible at ambient temperature (25° C.), especially chosen from polyols especially containing from 2 to 10 carbon atoms, preferably containing from 2 to 6 carbon atoms, such as glycerol, propylene glycol, 1,3-propanediol, butylene glycol, pentylene glycol, hexylene glycol, dipropylene glycol, diethylene glycol or diglycerol. Advantageously, the composition according to the invention comprises 1,3-propanediol, in particular in a content ranging from 0.1% to 20% by weight and preferably ranging from 0.1% to 10% by weight, preferentially ranging from 0.5% to 5% by weight, relative to the total weight of the composition.

The compositions according to the invention may be in the form of oil-in-water (O/W) emulsions, water-in-oil (W/O) emulsions or multiple emulsions (triple: W/O/W or O/W/O), oily solutions, oily gels, aqueous solutions, aqueous gels, or solid compositions. These compositions are prepared according to the usual methods.

The compositions according to the invention may be more or less fluid and may have the appearance of a white or coloured cream, an ointment, a milk, a lotion, a serum, a paste or a foam. They may be optionally applied to the skin in aerosol form. They may also be in solid form, for example in the form of a stick or a compact powder.

The composition according to the invention may especially be in the form of:
a makeup product, especially for making up the skin of the face, the body, or the lips or the eyelashes;
an aftershave gel or lotion; a shaving product;
a deodorant (stick, roll-on or aerosol);
a hair-removing cream;
a body hygiene composition such as a shower gel or a shampoo;
a pharmaceutical composition;
a solid composition such as a soap or a cleansing bar;
an aerosol composition also comprising a pressurized propellant;
a hairsetting lotion, a hair-styling cream or gel, a dye composition, a permanent-waving composition, a lotion or a gel for combating hair loss, or a hair conditioner;
a composition for caring for or cleansing the skin.

A subject of the invention is also a process for preparing a composition, especially a cosmetic or dermatological composition, comprising a step of mixing 4-(3-ethoxy-4-hydroxyphenyl)butan-2-one, the aromatic alcohol described previously and one or more additional ingredients, in particular cosmetic or dermatological ingredients, such as those described previously.

The invention is illustrated in greater detail in the example that follows. The amounts of the ingredients are expressed as weight percentages.

### EXAMPLE 1: DETERMINATION OF THE SYNERGISTIC ANTIMICROBIAL ACTIVITY AS MIC

The demonstration of a synergistic antimicrobial activity effect with a mixture of 4-(3-ethoxy-4-hydroxyphenyl)butan-2-one (referred to as substance A) and of aromatic alcohol (referred to as substance B) is performed by calculating the synergy index (or FIC index) according to the following formula:

FIC Index=(MIC of A with B/MIC of A)+(MIC of B with A/MIC of B)

with:
MIC of A with B: minimum concentration of product A in the combination A+B which makes it possible to obtain an inhibitory effect;
MIC of B with A: minimum concentration of product B in the combination A+B which makes it possible to obtain an inhibitory effect;
MIC of A: minimum inhibitory concentration of product A alone;
MIC of B: minimum inhibitory concentration of product B alone.

This formula was described for the first time in the article by F. C. Kull, P. C. Eisman, H. D. Sylwestrowka, and R. L. Mayer, Applied Microbiology 9:538-541, 1961.

For each compound tested alone, the MIC is considered as the first concentration which makes it possible to obtain a microbial growth percentage of less than or equal to 20%.

As regards the combinations tested, MIC of A with B and MIC of B with A are the respective concentrations of A and of B in the combinations which make it possible to obtain a microbial growth percentage of less than or equal to 20%.

Interpretation of the FIC Index:

When the FIC index value is less than or equal to 1, it is considered that the combination of test compounds has a synergistic effect.

The results obtained are summarized in the following tables.

The combination of compounds A and B was tested on the following strains or a part thereof: Aspergillus niger, Enterococcus faecalis, Staphylococcus aureus, Pseudomonas aeruginosa, Candida albicans.

The microbial strain Aspergillus niger ATCC 6275, and a double-concentration Sabouraud broth liquid culture medium supplemented with polyoxyethylenated (20 OE) sorbitan monopalmitate (Tween 40 from Croda) and Phytagel© BioReagent were used (i.e. a mixture of 5 g of Phytagel+0.6 g Tween 40+60 g of Sabouraud broth).

The microbial strain Enterococcus faecalis ATCC 33186 and a double-concentration BHI (Brain Heart Infusion) broth liquid culture medium were used.

The microbial strain Staphylococcus aureus ATCC 6538 and a double-concentration nutrient broth liquid culture medium were used.

The microbial strain Pseudomonas aeruginosa ATCC 9027 and a double-concentration nutrient broth liquid culture medium were used.

The microbial strain Candida albicans ATCC 10231 and a double-concentration Sabouraud broth liquid culture medium were used.

A 96-well microplate and an incubation temprature of 32.5° C. are used.

The incubation time of the microplate is:
from 18 to 24 h under aerobic conditions for Candida albicans ATCC 10231, Pseudomonas aeruginosa ATCC 9027 and Staphylococcus aureus ATCC 6538;
from 24 to 30 h under aerobic conditions for microbial Aspergillus niger ATCC 6275;
from 24 to 48 h under aerobic conditions for Enterococcus faecalis ATCC 33186.

Tests

For each compound:

A=4-(3-ethoxy-4-hydroxyphenyl) butan-2-one compound

B=aromatic alcohol compound

A 10% (weight/volume) stock solution was prepared by mixing 1 g of compound in 9 ml of aqueous 1‰ agar solution. Successive dilutions were made with the 1‰ agar solution.

Tests of Compounds A and B Alone

50 μl of each of the daughter solutions obtained containing compound A or B are added to the microplate wells. 100 μl of Sabouraud liquid nutrient broth inoculated at double concentration with the Aspergillus niger strain and 50 μl of aqueous 1‰ agar solution are also added thereto.

Tests of Compounds A and B as a Mixture

50 μl of each of the daughter solutions obtained containing compound A and 50 μl of each of the daughter solutions obtained containing compound B are added to the microplate wells. 100 μl of Sabouraud liquid nutrient broth inoculated at double concentration with the strain Aspergillus niger are also added thereto.

Microbial Growth Control

A positive microbial growth control was also prepared. The positive microbial growth control corresponds to a mixture of 100 μl of aqueous 1‰ agar solution with 100 μl of Sabouraud liquid nutrient broth inoculated at double concentration with the strain Aspergillus niger in the absence of compounds A and B.

Absorbance Control for Compounds A and B Alone

An absorbance control was performed in parallel on compounds A and B alone. This control corresponds to 100 μl of double concentration sterile Sabouraud liquid nutrient broth+100 μl of double concentration compound A or B.

In the three cases (absorbance control, growth control and test), the final volume present in each of the microplate wells is 200 μl.

In the two cases (test and control), the inoculum represents the concentration of the Aspergillus niger strain present in the final volume of the wells (200 μl) and is between 2 and 6×10⁵ cfu/ml of Aspergillus niger.

The minimum inhibitory concentration (MIC) of each compound A and B alone and in combination was determined in a known manner by means of optical density measurements at a wavelength of 620 nm.

The test as described above (tests, absorbance control and growth control) was performed again to test the combination A+B on the following strains Enterococcus faecalis, Staphylococcus aureus, Pseudomonas aeruginosa, Candida albicans.

The following results were obtained with compound B1=2-phenoxyethanol:

Aspergillus niger

Concentrations tested (in weight %)

| | 0 A | 0.0625 A | 0.125 A | 0.25 A |
|---|---|---|---|---|
| 0 B1 | | 85 | 47 | 7 |
| 0.0625 B1 | 95 | 76 | 37 | 5 |
| 0.125 B1 | 89 | 34 | 14 | 2 |
| | | | (FIC 1) | |
| 0.25 B1 | 8 | 3 | 2 | 2 |

| % MIC | % MIC | MIC of each compound | | | |
|---|---|---|---|---|---|
| of A | of B1 | as a mixture | | | |
| alone | alone | A % | B1 % | FIC Index | Ratio A/B1 |
| 0.25 | 0.25 | 0.125 | 0.125 | 1 | 1 |

The results obtained show synergistic inhibitory activity for the mixture: 0.125% of A and 0.125% of B1, i.e. ratio A/B1=1

Enterococcus faecalis

| | Concentrations tested (in weight %) | | | | | |
|---|---|---|---|---|---|---|
| | 0 A | 0.0625 A | 0.125 A | 0.25 A | 0.5 A | 1 A |
| 0 B1 | | 82 | 89 | 89 | 75 | 13 |
| 0.0625 B1 | 87 | 83 | 87 | 97 | 82 | 34 |
| 0.125 B1 | 86 | 90 | 80 | 95 | 73 | 30 |
| 0.25 B1 | 84 | 95 | 75 | 83 | 74 | 30 |
| 0.5 B1 | 80 | 79 | 68 | 5 (FIC 0.75) | 37 | 2 |
| 1 B1 | 6 | 6 | 2 | 3 | 2 | −23 |

| | | MIC of each | | | |
|---|---|---|---|---|---|
| % MIC of | % MIC of | compound | | | |
| A | B1 | as a mixture | | FIC | Ratio |
| alone | alone | A % | B1% | Index | A/B1 |
| 1 | 1 | 0.25 | 0.5 | 0.75 | 0.5 |

The results obtained show synergistic inhibitory activity for the mixture: 0.25% of A and 0.5% of B1, i.e. ratio A/B1=0.5

Staphylococcus aureus

| | Concentrations tested (in weight %) | | | | |
|---|---|---|---|---|---|
| | 0 A | 0.0625 A | 0.125 A | 0.25 A | 0.5 A |
| 0 B1 | | 71 | 57 | 52 | 1 |
| 0.0625 B1 | 66 | 68 | 62 | 38 | 1 |
| 0.125 B1 | 73 | 65 | 55 | 17 (FIC 2) | 1 |
| 0.25 B1 | 58 | 43 | 15 (FIC 0.5) | 1 (FIC 1) | 0 |
| 0.5 B1 | 1 | 1 | 0 | 1 | 0 |

| | | | | |
|---|---|---|---|---|
| | | MIC of each | | |
| % MIC of | % MIC of | compound | | |
| A | B1 | as a mixture | FIC | Ratio |

| alone | alone | A % | B1% | Index | A/B1 |
|---|---|---|---|---|---|
| 0.5 | 0.5 | 0.25 | 0.25 | 1 | 0.5 |

The results obtained show synergistic inhibitory activity for the mixtures:
i) 0.25% of A and 0.125% of B1, i.e. ratio A/B1=2
ii) 0.125% of A and 0.25% of B1, i.e. ratio A/B1=0.5
iii) 0.25% of A and 0.25% of B1, i.e. ratio A/B1=1

Pseudomonas aeruginosa

| | Concentrations tested (in weight %) | | | | | |
|---|---|---|---|---|---|---|
| | 0 A | 0.0625 A | 0.125 A | 0.25 A | 0.5 A | 1 A |
| 0 B1 | | 49 | 82 | 116 | 67 | −4 |
| 0.0625 B1 | 45 | 86 | 118 | 92 | 87 | 27 |
| 0.125 B1 | 39 | 89 | 82 | 95 | 78 | 16 |
| 0.25 B1 | 39 | 16 (FIC 0.25) | 14 (FIC 0.5) | 10 (FIC 1) | 0 (FIC 2) | 20 |
| 0.5 B1 | 0 | 0 | 0 | 0 | 0 | 65 |
| 1 B1 | 0 | 0 | 0 | 0 | 0 | 14 |

| | | | | |
|---|---|---|---|---|
| | | MIC of each | | |
| % MIC of | % MIC of | compound | | |
| A | B1 | as a mixture | FIC | Ratio |

| alone | alone | A % | B1% | Index | A/B1 |
|---|---|---|---|---|---|
| 1 | 0.5 | 0.5 | 0.25 | 1 | 0.25 |

The results obtained show synergistic inhibitory activity for the mixtures:
i) 0.0625% of A and 0.25% of B1, i.e. ratio A/B1=0.25
ii) 0.125% of A and 0.25% of B1, i.e. ratio A/B1=0.5
iii) 0.25% of A and 0.25% of B1, i.e. ratio A/B1=1
iv) 0.5% of A and 0.25% of B1, i.e. ratio A/B1=2

Candida Albicans

Concentrations tested (in weight %)

| | 0 A | 0.025 A | 0.05 A | 0.1 A |
|---|---|---|---|---|
| 0 B1 | | 48 | 29 | 16 |
| 0.0625 B1 | 44 | 26 | 17 | 8 |
| | | | (FIC 0.75) | |
| 0.125 B1 | 22 | 10 | 5 | 1 |
| | | (FIC 0.75) | (FIC 1) | |
| 0.25 B1 | 2 | 1 | 1 | 1 |

| % MIC | % MIC | MIC of each compound | | | |
|---|---|---|---|---|---|
| of A | of B1 | as a mixture | | FIC | Ratio |
| alone | alone | A % | B1% | Index | A/B1 |
| 0.1 | 0.25 | 0.05 | 0.125 | 0.75 | 0.2 |

The results obtained show synergistic inhibitory activity for the mixtures:
i) 0.05% of A and 0.0625% of B1, i.e. ratio A/B1=0.8
ii) 0.05% of A and 0.125% of B1, i.e. ratio A/B1=0.4
iii) 0.025% of A and 0.125% of B1, i.e. ratio A/B1=0.2

### EXAMPLE 2: DETERMINATION OF THE ANTIMICROBIAL ACTIVITY OF THE ANTIMICROBIAL MIXTURE

The antimicrobial efficacy of the 4-(3-ethoxy-4-hydroxyphenyl)butan-2-one+2-phenoxyethanol antimicrobial mixture (respective weight ratio of 0.1) was evaluated by the Challenge Test method.

Protocol

The method of the challenge test is constituted of an artificial contamination of the sample with microbial strains from collection (bacteria, yeasts and moulds) and of an evaluation of the number of revivable microorganisms seven days after inoculation.

In order to demonstrate the effect of the antimicrobial mixture, the antimicrobial activity of a cosmetic formula containing 0.05% of 4-(3-ethoxy-4-hydroxyphenyl)butan-2-one and 0.5% of 2-phenoxyethanol was compared with the same formula alone (control), after inoculation with about 10⁶ cfu (colony-forming units)/gram of cosmetic formulation.

Cosmetic Formula

A facial care oil-in-water emulsion having the following composition was prepared (contents in weight percentages):

| Sorbitan tristearate (Span 65 V from Croda) | | 0.9% |
|---|---|---|
| Glyceryl mono/distearate (36/64)/potassium stearate | | |
| mixture | | |
| (Tegin Pellets from Goldschmidt) | | 3% |
| Polyethylene glycol stearate (40 ethylene oxide units) | | 2% |
| 4-(3-ethoxy-4-hydroxyphenyl)butan-2-one | | 0.05% |
| 2-Phenoxyethanol | | 0.5% |
| Propane-1,3-diol | | 2% |
| Mineral oil, microcrystalline wax and paraffin mixture | | |
| (Vaseline Blanche Codex 236 from Aiglon) | | 4% |
| Liquid fraction of shea butter (Shea Olein from Olvea) | | 1% |
| Cyclopentadimethylsiloxane | | 5% |
| Cetyl alcohol | | 4% |
| Apricot kernel oil | | 0.3% |
| Hydrogenated polyisobutene (Parleam from NOF Corporation) | | 7.2% |
| Myristyl myristate | | 2% |
| Stearic acid | | 1.2% |
| Caffeine | | 0.1% |
| Citric acid | | 0.2% |
| Glycerol | | 3% |
| Sodium hydroxide | | 0.05% |
| Water | qs | 100% |

Control Formula A:

Formulation similar to the preceding one containing 0.05% of 4-(3-ethoxy-4-hydroxyphenyl)butan-2-one and without 2-phenoxyethanol (0.5% compensated with water).

Control Formula B:

Similar formulation containing 0.5% of 2-phenoxyethanol and without 4-(3-ethoxy-4-hydroxyphenyl)butan-2-one (0.05% compensated with water).

Microorganism Cultures

5 pure cultures of microorganisms were used.

| MICROORGANISMS | Subculturing medium | T° | ATCC |
|---|---|---|---|
| Escherichia coli (Ec) | Trypto-casein soya | 35° C. | 8739 |
| Enterococcus faecalis (Ef) | Trypto-casein soya | 35° C. | 33186 |
| Pseudomonas aeruginosa (Pa) | Trypto-casein soya | 35° C. | 19429 |
| Candida albicans (Ca) | Sabouraud | 35° C. | 10231 |
| Aspergillus niger (An) | Malt | 35° C. | 6275 |

ATCC = American Type Culture Collection

The strains of gram-negative bacteria (Escherichia coli and Pseudomonas aeruginosa), gram-positive bacterium (Enterococcus faecalis), yeast (Candida albicans), and mould (Aspergillus niger) are inoculated into subculturing medium, respectively the day before inoculation for the bacteria and the yeast, and 5 days before inoculation for the mould.

On the day of inoculation:
a suspension in tryptone salt diluent is prepared, respectively, for the bacteria and the yeast, so as to obtain by spectrophotometer a suspension with an optical density of between 35% and 45% of transmitted light at 544 nm;
for the mould, the spores are collected by washing the agar with 6 to 7 ml of harvesting solution and the suspension is recovered in a sterile tube or flask.

After homogenizing the microbial suspension, 0.2 ml of inoculum is introduced into each pill bottle (the suspensions are used pure: between 1×10⁸ and 3×10⁸ cfu per ml) and the microbial suspension in the 20 g of product (=cosmetic formulation) is homogenized thoroughly using a spatula.

The content of microorganisms present in the product corresponds after homogenization to a concentration of 10⁶ microorganisms per gram of product, i.e. inoculation to 1% of an inoculum containing 10⁸ microorganisms per ml.

After 7 days of contact time between the microorganisms and the product at 22° C.±2° C. and in the dark, ten-fold dilutions are carried out and the number of revivable microorganisms remaining in the product is counted.

Results

| | No. of CFU/gram of product at T7 days | | | | |
|---|---|---|---|---|---|
| | | P. | | C. | |
| | E. coli | aeruginosa | E. faecalis | albicans | A. niger |
| Antimicrobial | <200 | <200 | <200 | <200 | <200 |
| mixture | | | | | |

<200 CFU: sensitivity threshold of the method

### EXAMPLE 3: DETERMINATION OF THE SYNERGISTIC ANTIMICROBIAL ACTIVITY IN MIC ON THE MICROBIAL STRAIN CANDIDA ALBICANS

The demonstration of a synergistic antimicrobial activity effect with a mixture of 4-(3-ethoxy-4-hydroxyphenyl)butan-2-one (referred to as substance A) and of phenylethyl alcohol (referred to as substance B2) is performed according to the conditions described in Example 1.

The following results were obtained:

| | concentrations tested (in weight %) | | | | |
|---|---|---|---|---|---|
| | 0 A | 0.025 A | 0.05 A | 0.1 A | 0.2 A |
| 0 B2 | | 85 | 64 | 25 | 3 |
| 0.125 B2 | 41 | 23 | 14 | 7 | 0 |
| | | | (FIC 0.75) | (FIC 1) | |
| 0.25 B2 | 7 | 2 | 1 | 0 | 0 |

| | | MIC of each compound | | | |
|---|---|---|---|---|---|
| | | as a mixture | | | |
| % MIC A | MIC B2 | A % | B2% | FIC Index | |
| 0.2 | 0.25 | 0.05 | 0.125 | 0.75 | Ratio A/ |
| | | | | | B2 = 0.4 |

The results obtained show synergistic inhibitory activity for the mixtures:
i) 0.025% of A and 0.125% of B2, i.e. ratio A/B2=0.2
ii) 0.05% of A and 0.125% of B2, i.e. ratio A/B2=0.4
iii) 0.1% of A and 0.125% of B2, i.e. ratio A/B2=0.8

### EXAMPLE 4: DETERMINATION OF THE ANTIMICROBIAL ACTIVITY OF THE ANTIMICROBIAL MIXTURE

The antimicrobial efficacy of the 4-(3-ethoxy-4-hydroxyphenyl)butan-2-one+2-phenylethyl alcohol antimicrobial mixture (respective weight ratio of 0.1) was evaluated by the Challenge Test method according to the protocol described in Example 2.

Cosmetic Formula

A facial care oil-in-water emulsion having the following composition was prepared (contents in weight percentages):

| Sorbitan tristearate (Span 65 V from Croda) | | 0.9% |
|---|---|---|
| Glyceryl mono/distearate (36/64)/potassium stearate | | |
| mixture | | |
| (Tegin Pellets from Goldschmidt) | | 3% |
| Polyethylene glycol stearate (40 ethylene oxide units) | | 2% |
| 4-(3-ethoxy-4-hydroxyphenyl)butan-2-one | | 0.05% |
| Phenylethyl alcohol | | 0.5% |
| Propane-1,3-diol | | 2% |
| Mineral oil, microcrystalline wax and paraffin mixture | | |
| (Vaseline Blanche Codex 236 from Aiglon) | | 4% |
| Liquid fraction of shea butter (Shea Olein from Olvea) | | 1% |
| Cyclopentadimethylsiloxane | | 5% |
| Cetyl alcohol | | 4% |
| Apricot kernel oil | | 0.3% |
| Hydrogenated polyisobutene (Parleam from NOF Corporation) | | 7.2% |
| Myristyl myristate | | 2% |
| Stearic acid | | 1.2% |
| Caffeine | | 0.1% |
| Citric acid | | 0.2% |
| Glycerol | | 3% |
| Sodium hydroxide | | 0.05% |
| Water | qs | 100% |

Results

| | No. of CFU/gram of product at T7 days | | | | |
|---|---|---|---|---|---|
| | | P. | | C. | |
| | E. coli | aeruginosa | E. faecalis | albicans | A. niger |
| Antimicrobial | <200 | <200 | <200 | <200 | <200 |
| mixture | | | | | |

<200 CFU: sensitivity threshold of the method

### EXAMPLE 5: DETERMINATION OF THE SYNERGISTIC ANTIMICROBIAL ACTIVITY AS MIC

The demonstration of a synergistic antimicrobial activity effect with a mixture of 4-(3-ethoxy-4-hydroxyphenyl)butan-2-one (referred to as substance A) and of benzyl alcohol (referred to as substance B3) is performed according to the conditions described in Example 1.

The following results were obtained:

Aspergillus niger

concentrations tested (in weight %)

| | 0 A | 0.0625 A | 0.125 A | 0.25 A |
|---|---|---|---|---|
| 0 B3 | | 86 | 41 | 6 |
| 0.0125 B3 | 94 | 49 | 24 | 3 |
| 0.25 B3 | 31 | 7 | 3 | 2 |
| | | (FIC 0.75) | (FIC 1) | |
| 0.5 B3 | 1 | 2 | 1 | 2 |

| % MIC | % MIC | MIC of each compound | | | |
|---|---|---|---|---|---|
| of A | of B3 | as a mixture | | | |
| alone | alone | A % | B3% | FIC Index | |
| 0.25 | 0.5 | 0.0625 | 0.25 | 0.75 | Ratio A/ |
| | | | | | B3 = 0.25 |

The results obtained show synergistic inhibitory activity for the mixtures:
i) 0.0625% of A and 0.25% of B3, i.e. ratio A/B3=0.25
ii) 0.125% of A and 0.25% of B3, i.e. ratio A/B3=0.5

Enteroccoccus faecalis

| | concentrations tested (in weight %) | | | | | |
|---|---|---|---|---|---|---|
| | 0 A | 0.0625 A | 0.125 A | 0.25 A | 0.5 A | 1 A |
| 0 B3 | | 78 | 86 | 92 | 72 | 4 |
| 0.25 B3 | 77 | 76 | 79 | 59 | 45 | 6 |
| 0.5 B3 | 30 | 6 (FIC 0.56) | 3 (FIC 0.63) | 2 (FIC 0.75) | 3 (FIC 1) | 21 |
| 1 B3 | 3 | 5 | 2 | 4 | 3 | −2 |

| | | MIC of each | | | |
|---|---|---|---|---|---|
| % MIC of | % MIC of | compound | | | |
| A | B3 | as a mixture | | FIC | |
| alone | alone | A % | B3% | Index | |
| 1 | 1 | 0.0625 | 0.5 | 0.56 | Ratio A/B3 = 0.125 |

The results obtained show synergistic inhibitory activity for the mixture:
i) 0.0625% of A and 0.5% of B3, i.e. ratio A/B3=0.125
ii) 0.125% of A and 0.5% of B3, i.e. ratio A/B3=0.25
iii) 0.25% of A and 0.5% of B3, i.e. ratio A/B3=0.5
iv) 0.5% of A and 0.5% of B3, i.e. ratio A/B3=1

### EXAMPLE 6: DETERMINATION OF THE SYNERGISTIC ANTIMICROBIAL ACTIVITY AS MIC

The demonstration of a synergistic antimicrobial activity effect with a mixture of 4-(3-ethoxy-4-hydroxyphenyl)butan-2-one (referred to as substance A) and of 4-isopropyl-3-methylphenol (referred to as substance B4) is performed according to the method described in Example 1.

The following results were obtained:

Candida Albicans

| | Concentrations tested (in weight %) | | | | |
|---|---|---|---|---|---|
| | 0 de A | 0.025 A | 0.05 A | 0.1 A | 0.2 A |
| 0 of B4 | | 69 | 63 | 38 | 4 |
| 0.0025 B4 | 87 | 77 | 63 | 41 | 6 |
| 0.005 B4 | 82 | 58 | 54 | 28 | 2 |
| 0.01 B4 | 73 | 52 | 41 | 18 | 2 |
| | | | | (FIC 0.75) | |
| 0.02 B4 | 35 | 18 | 8 | 3 | 1 |
| | | (FIC 0.63) | (FIC 0.75) | (FIC 1) | |
| 0.04 B4 | 1 | 1 | 1 | 1 | 0 |

| % MIC | % MIC | MIC of each compound | | | |
|---|---|---|---|---|---|
| of A | of B4 | as a mixture | | | Ratio |
| alone | alone | A % | B4% | FIC Index | A/B4 |
| 0.2 | 0.04 | 0.025 | 0.2 | 0.63 | 1.25 |

The results obtained show synergistic inhibitory activity for the mixtures:
i) 0.025% of A and 0.02% of B4, i.e. ratio A/B4=1.25
ii) 0.05% of A and 0.02% of B4, i.e. ratio A/B4=2.5
iii) 0.1% of A and 0.02% of B4, i.e. ratio A/B4=5
iv) 0.1% of A and 0.01% of B4, i.e. ratio A/B4=10

Enterococcus Faecalis

| | Concentrations tested (in weight %) | | | | | |
|---|---|---|---|---|---|---|
| | 0 of A | 0.0625 A | 0.125 A | 0.25 A | 0.5 A | 1 A |
| 0 of B4 | | 42 | 42 | 33 | 34 | 24 |
| 0.0125 B4 | 45 | 41 | 41 | 37 | 40 | 21 |
| 0.025 B4 | 44 | 36 | 38 | 30 | 36 | −19 |
| 0.05 B4 | 27 | 39 | 12 (FIC 0.625) | 11 (FIC 0.75) | 11 (FIC 1) | −27 |
| 0.1 B4 | 23 | −18 | 7 | 8 | −4 | −90 |

| | | MIC of each | | | |
|---|---|---|---|---|---|
| % MIC of | % MIC of | compound | | | |
| A | B4 | as a mixture | | FIC | Ratio |
| alone | alone | A % | B4% | Index | A/B4 |
| 1 | 0.1 | 0.125 | 0.05 | 0.63 | 1.25 |

The results obtained show synergistic inhibitory activity for the mixtures:
i) 0.125% of A and 0.05% of B4, i.e. ratio A/B4=1.25
ii) 0.25% of A and 0.05% of B4, i.e. ratio A/B4=2.5
iii) 0.5% of A and 0.05% of B4, i.e. ratio A/B4=10

1. An antimicrobial mixture comprising 4-(3-ethoxy-4-hydroxyphenyl)butan-2-one and an aromatic alcohol chosen from:
i) a phenoxyalcohol of formula C₆H₅—O—R—OH, R denoting a divalent hydrocarbon-based radical having 2 or 3 carbon atoms;
ii) phenylethyl alcohol;
ii) benzyl alcohol; and
iv) a cresol compound of formula (I): 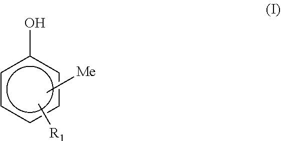
in which R₁ denotes H or an isopropyl radical.

2. The antimicrobial mixture according to claim 1, wherein the aromatic alcohol is a phenoxyalcohol of formula C₆H₅—O—R—OH, R denoting a divalent hydrocarbon-based radical having 2 or 3 carbon atoms.

3. The antimicrobial mixture according to claim 2, wherein said phenoxyalcohol is chosen from 2-phenoxyethanol or 1-phenoxy-2-propanol.

4. The antimicrobial mixture according to claim 2, wherein said phenoxyalcohol is 2-phenoxyethanol.

5. The antimicrobial mixture according to claim 2, which comprises 4-(3-ethoxy-4-hydroxyphenyl)butan-2-one and phenoxyalcohol in amounts such that the 4-(3-ethoxy-4-hydroxyphenyl)butan-2-one/2-phenoxyalcohol weight ratio ranges from 0.15 to 3.5.

6. The antimicrobial mixture according to claim 2, which has a 4-(3-ethoxy-4-hydroxyphenyl)butan-2-one/phenoxyalcohol weight ratio ranging from 0.3 to 3.2.

7. The antimicrobial mixture according to claim 2, which has a 4-(3-ethoxy-4-hydroxyphenyl)butan-2-one/phenoxyalcohol weight ratio ranging from 0.4 to 0.8.

8. The antimicrobial mixture according to claim 2, which has a 4-(3-ethoxy-4-hydroxyphenyl)butan-2-one/phenoxyalcohol weight ratio ranging from 0.15 to 1.3.

9. The antimicrobial mixture according to claim 1, which has a 4-(3-ethoxy-4-hydroxyphenyl)butan-2-one/phenoxyalcohol weight ratio ranging from 0.6 to 1.6.

10. The antimicrobial mixture according to claim 1, which has a 4-(3-ethoxy-4-hydroxyphenyl)butan-2-one/phenoxyalcohol weight ratio ranging from 0.2 to 3.2, preferably ranging from 0.4 to 3.2.

11. The antimicrobial mixture as claimed in claim 1, wherein the aromatic alcohol is phenylethyl alcohol.

12. The antimicrobial mixture according to claim 11, which comprises 4-(3-ethoxy-4-hydroxyphenyl)butan-2-one and phenylethyl alcohol in amounts such that the 4-(3-ethoxy-4-hydroxyphenyl)butan-2-one/phenylethyl alcohol weight ratio ranges from 0.05 to 1.

13. The antimicrobial mixture as claimed in claim 1, wherein the aromatic alcohol is benzyl alcohol.

14. The antimicrobial mixture according to claim 13, which comprises 4-(3-ethoxy-4-hydroxyphenyl)butan-2-one and benzyl alcohol in amounts such that the 4-(3-ethoxy-4-hydroxyphenyl)butan-2-one/benzyl alcohol weight ratio ranges from 0.1 to 1.5.

15. The antimicrobial mixture as claimed in claim 1, wherein the aromatic alcohol is a cresol compound of formula (I): 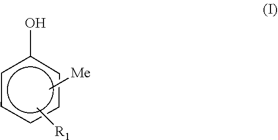
in which R₁ denotes H or an isopropyl radical.

16. The antimicrobial mixture according to claim 15, wherein the cresol compound of formula (I) is chosen from 2-methylphenol, 3-methylphenol, 4-methylphenol, and 4-isopropyl-3-methylphenol.

17. The antimicrobial mixture according to claim 15, wherein cresol compound of formula (I) is 4-isopropyl-3-methylphenol.

18. The antimicrobial mixture according to claim 15, which comprises 4-(3-ethoxy-4-hydroxyphenyl)butan-2-one and the cresol compound (I) in amounts such that the 4-(3-ethoxy-4-hydroxyphenyl)butan-2-one/cresol compound (I) weight ratio ranges from 0.5 to 15.

19. The antimicrobial mixture according to claim 15, which has a 4-(3-ethoxy-4-hydroxyphenyl)butan-2-one/cresol compound (I) weight ratio ranging from 2 to 15.

20. A composition comprising, in a physiologically acceptable medium, an antimicrobial mixture according to claim 1.

21. The composition according to claim 20, which comprises at least one additional ingredient chosen from water, oils, polyols containing from 2 to 10 carbon atoms, gelling agents, surfactants, film-forming polymers, colorants, fragrances, fillers, UV-screening agents, plant extracts, cosmetic and dermatological active agents, and salts.

22. The composition according to claim 20, wherein the 4-(3-ethoxy-4-hydroxyphenyl)butan-2-one is present in a content ranging from 0.01% to 5% by weight relative to the total weight of the composition.

23. A non-therapeutic Non therapeutic cosmetic treatment process for caring for and/or making up and/or cleansing keratin materials, comprising the application to said keratin materials of a composition according to claim 20.

24. A process for conserving a composition comprising a physiologically acceptable medium which comprises incorporating into said composition an antimicrobial mixture as defined in claim 1.
